(19) United States
(12) Patent Application Publication
(10) Pub. No.: US 2005/0088154 A1
(43) Pub. Date: Apr. 28, 2005

(54) Voltage regulator

(76) Inventor: Masakazu Sugiura, Chiba-shi (JP)

Correspondence Address: ADAMS & WILKS, 31st FLOOR, 50 BROADWAY, NEW YORK, NY, 10004, US

(21) Appl. No.: 10/960,196

(22) Filed: Oct. 7, 2004

(30) Foreign Application Priority Data
Oct. 8, 2003 (JP) 2003-349171

(51) Int. Cl. G05F 1/40

(52) U.S. Cl. 323/281

(57) ABSTRACT

To provide a voltage regulator that improves an undershoot characteristic with a low current consumption. A voltage regulator includes an error amplifier; an output MOS transistor; and a circuit for detecting that a constant voltage to which an output voltage is to be controlled is lower than a desired value, and increasing an operating current of the error amplifier.

### BACKGROUND OF THE INVENTION

1. Field of the Invention

The present invention relates to an improvement in an undershoot characteristic of a voltage regulator.

2. Description of the Related Art

FIG. 3 is a circuit diagram showing a conventional voltage regulator. The conventional voltage regulator includes a voltage regulator control circuit and an output MOS transistor 14. The voltage regulator control circuit is made up of a reference voltage circuit 10 that outputs a reference voltage Vref1, breeder resistors 11 and 12 which output a voltage Va obtained by dividing an output voltage Vout of an output terminal 6, and an error amplifier 13 that amplifies a difference between the reference voltage Vref1 and a voltage Va and outputs a voltage Verr. The voltage regulator operates by means of a voltage VDD1 that is given by a voltage source 15. The voltage Verr that is outputted based on a relationship between the voltage Va and Vref1 which are inputted to the error amplifier 13 becomes lower if Vref1>Va and higher if Vref1<Va.

Since a p-ch MOS is used as the output MOS transistor 14, when Verr becomes lower, a voltage between a gate and a source of the output MOS transistor 14 becomes higher, and an on-resistance becomes smaller so that the output voltage Vout rises. When Verr becomes higher, the on-resistance of the output MOS transistor 14 increases so that the output voltage becomes lower. In this manner, the output voltage Vout is kept to a constant value (for example, refer to JP 4-195613 A (pp. 1 to 3, FIG. 2).

Although being omitted from the above conventional example, it is necessary to appropriately add a phase compensation capacitor as occasion demands in the case of a general voltage regulator. Also, the error amplifier 13 is made up of a current mirror circuit including a p-ch MOS transistor 16 and a p-ch MOS transistor 17, an input differential pair including an n-ch MOS transistor 18 and an n-ch MOS transistor 19, and a constant current circuit 20 into which a constant current I1 flows.

However, in the conventional voltage regulator, the operating current of the error amplifier 13 is determined by the constant current circuit 20. Accordingly, in order to realize the voltage regulator that is low in the current consumption, a current in the constant current circuit is reduced. In this case, when a load that is connected to the output terminal 6 becomes rapidly heavy, a tendency that the output voltage Vout exhibits the undershoot characteristic becomes high. This leads to a problem in that a load fluctuation characteristic is sacrificed. On the other hand, when the undershoot characteristic of the regulator is going to be improved, the current in the constant current circuit 20 increases. This leads to a problem in that the current consumption increases.

In the case where a battery is used for a power supply, a low current consumption characteristic is required in order to prolong the lifetime of the battery. As a result, the undershooting occurs in the output voltage Vout of the voltage regulator, and an external element to be connected to the output terminal of the voltage regulator is limited to an element that is low in the lowest driving voltage. The limit of the applied element as described above must be avoided as much as possible. On the other hand, in order to improve the undershoot characteristic of the voltage regulator and to widen the band of the error amplifier 13, an increase in the operating current of the error amplifier 13 is basically unavoidable.

### SUMMARY OF THE INVENTION

Under the above circumstances, the present invention has been made to solve the above problems with the conventional voltage regulator, and therefore an object of the present invention is to provide a voltage regulator that improves an undershoot characteristic with a low current consumption.

To achieve the above object, the present invention applies the following means.

A voltage regulator includes:
an error amplifier;
an output MOS transistor; and
a circuit for detecting that a constant voltage to which an output voltage is to be controlled is lower than a desired value, and increasing an operating current of the error amplifier.

Also, according to the present invention, a current increased by a circuit for increasing the operating current of the error amplifier can be changed.

Also, according to the present invention, a voltage detected by the circuit that increases the operating current of the error amplifier can be changed.

As described above, according to the voltage regulator of the present invention, only when a constant voltage to which an output voltage is to be controlled is lower than a desired value, the operating current of the error amplifier that structures the voltage regulator is temporarily largely controlled, and the band of the error amplifier is widened so as to improve the undershoot characteristic. In other cases, the operating current of the error amplifier that structures the voltage regulator is made small with the result that the current consumption can be low.

### BRIEF DESCRIPTION OF THE DRAWINGS

In the accompanying drawings:

FIG. 1 is a circuit diagram showing a voltage regulator according to a first embodiment of the present invention;

FIG. 2 is a circuit diagram showing an example of a current adder circuit of the voltage regulator according to the first embodiment of the present invention;

FIG. 3 is an explanatory diagram showing a circuit of a conventional voltage regulator;

FIG. 4 is an explanatory diagram showing a circuit of another conventional voltage regulator;

FIG. 5 is a circuit diagram showing a voltage regulator according to a second embodiment of the present invention; and

FIG. 6 is a circuit diagram showing a voltage regulator according to a third embodiment of the present invention.

### DETAILED DESCRIPTION OF THE PREFERRED EMBODIMENTS

Now, a description will be given in more detail of preferred embodiments of the present invention with reference to the accompanying drawings.

### FIRST EMBODIMENT

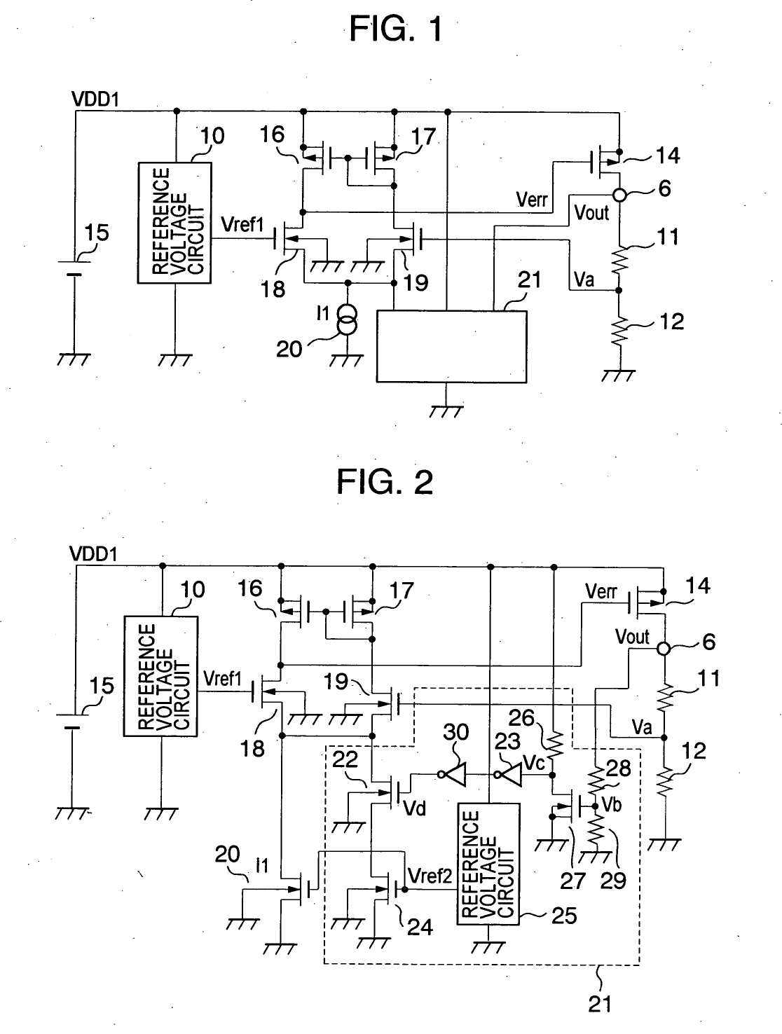

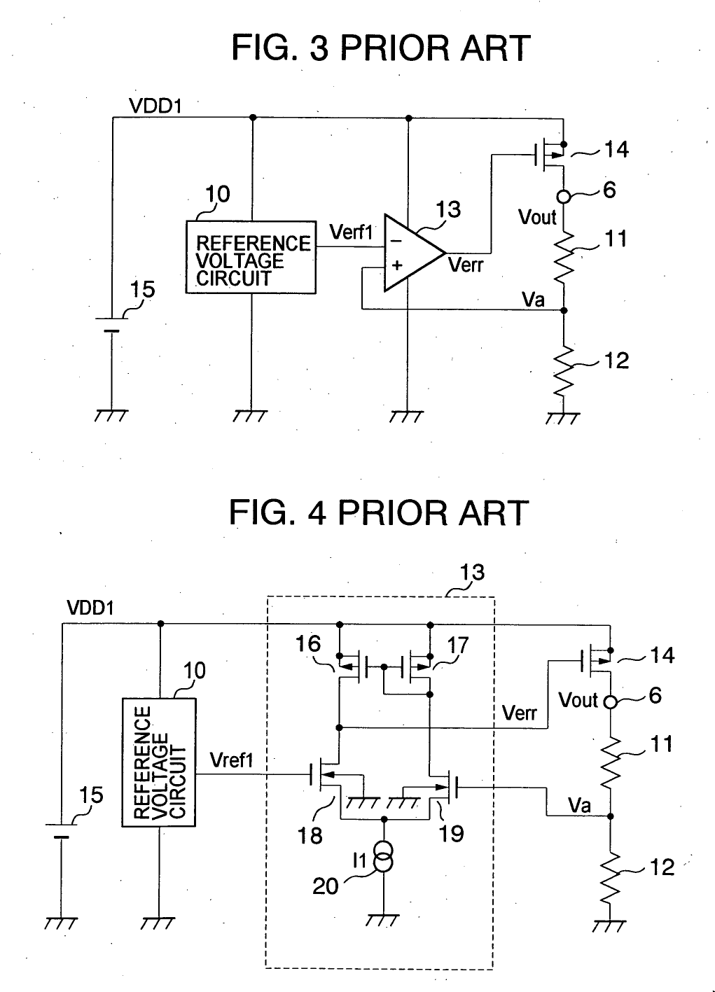

FIG. 1 is a circuit diagram showing a voltage regulator according to a first embodiment of the present invention. A difference of FIG. 1 from FIG. 4 resides in the provision of a current adder circuit 21. The current adder circuit 21 operates to increase the operating current of an error amplifier in a state where it is detected that a constant voltage to which an output voltage Vout is to be controlled is lower than a desired value.

The current adder circuit 21 includes, for example as shown in FIG. 2, a breeder resistor 28 and a breeder resistor 29 which divide the output voltage Vout, an n-channel MOS transistor 27 whose on/off operation is controlled by means of a voltage Vb at a node of the breeder resistor 28 and the breeder resistor 29, and a resistor 26 for pulling up a drain of the n-channel MOS transistor 27. The current adder circuit 21 also includes an inverter 23 and an inverter 30 which input a voltage Vc at a node of the drain of the n-channel MOS transistor 27 and the resistor 26, and functions for the purpose of waveform shaping, an n-channel MOS transistor 22 whose on/off operation is controlled according to an output voltage Vd of the inverter 30, a reference voltage circuit 25 that outputs a reference voltage Vref2, and an n-channel MOS transistor 24 having a gate to which the reference voltage Vref2 is supplied. This structure corresponds to a portion surrounded by a dotted line in FIG. 2. In FIG. 2, the constant current circuit 20 is made up of an n-channel MOS transistor having a gate to which the reference voltage Vref2 is supplied.

In the case where the output voltage Vout becomes high, and Vb is a voltage that turns on the n-channel MOS transistor 27, a voltage of Vc becomes low (hereinafter referred to as “L”) due to a voltage drop that is developed in the resistor 26. On the other hand, in the case where the output voltage Vout becomes low, and Vb is a voltage that turns off the n-channel MOS transistor 27, a voltage of Vc becomes high (hereinafter referred to as “H”). In this case, if Vc is “L”, the output voltage Vd of the inverter 30 becomes “L”, and the n-channel MOS transistor 22 turns off. In this situation, a drain current does not flow in the n-channel MOS transistor 24, and the operating current of the error amplifier is only a current I1 from the constant current circuit 20.

Also, if Vc is “H”, the output voltage Vd of the inverter 30 becomes “H”, and the n-channel MOS transistor 22 turns on. In this situation, a drain current I2 flows in the n-channel MOS transistor 24, and the operating current of the error amplifier is added by as much as the drain current I2. The output voltage Vout for causing Vb to turn on or off the n-channel MOS transistor 27 can be set by adjusting the resistances of the breeder resistor 28 and the breeder resistor 29 to appropriate values, and it is possible to detect that a constant voltage to which the output voltage Vout is to be controlled is lower than a desired value, and the operating current of the error amplifier is increased.

Accordingly, the undershoot characteristic is improved by widening the band of the error amplifier, and the operating current of the error amplifier that structures the voltage regulator is made small, thereby making it possible to reduce the current consumption.

In the conventional voltage regulator, the operating current of the error amplifier 13 is determined by the constant current circuit 20. Therefore, when the current in the constant current circuit 20 is reduced in order to realize the voltage regulator that is low in the current consumption, and when a load that is connected to an output terminal 6 of the voltage regulator becomes rapidly heavy, a tendency that the output voltage Vout exhibits the undershoot characteristic becomes high. That is, a power supply start characteristic is sacrificed. On the other hand, when the current in the constant current circuit 20 is increased in order to realize the voltage regulator whose undershoot characteristic is improved, it is possible to eliminate a problem in that the low current consumption characteristic is sacrificed.

### SECOND EMBODIMENT

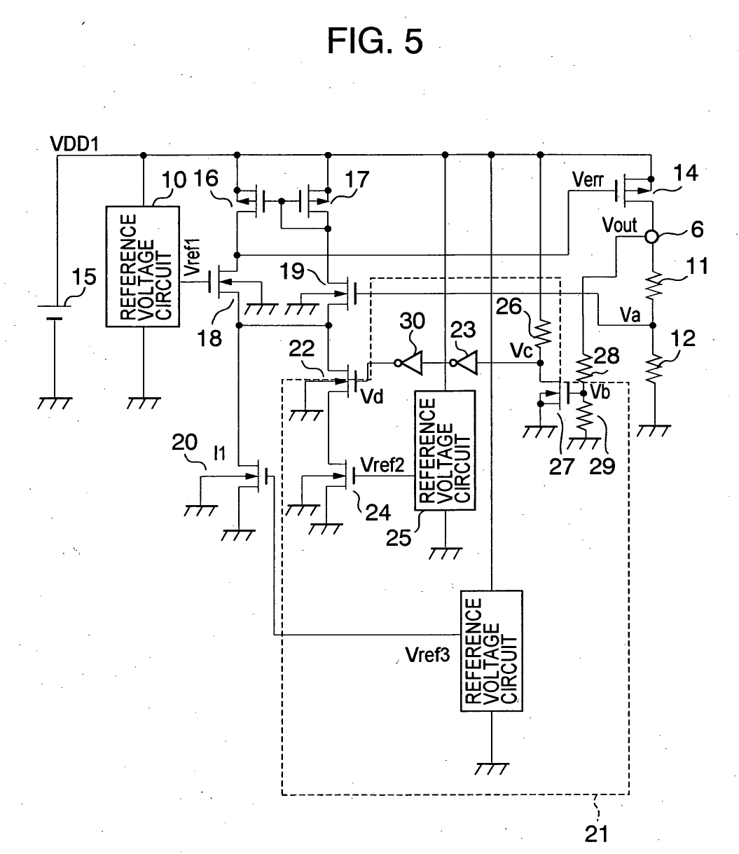

FIG. 5 is a circuit diagram showing a voltage regulator in accordance with a second embodiment of the present invention.

In the voltage regulator of the first embodiment, the reference voltage Vref2 is applied to the gate of the n-channel MOS transistor that structures the constant current circuit 20 and the n-channel MOS transistor 24. In the voltage regulator of the second embodiment, a reference voltage Vref3 is newly added so as to apply the reference voltages to the respective n-channel transistors, independently. When the values of the reference voltages Vref2 and Vref3 are arbitrarily given, a current that is increased by the current adder circuit 21 can be varied. Thus, there is an advantage in that the current can be arbitrarily set.

### THIRD EMBODIMENT

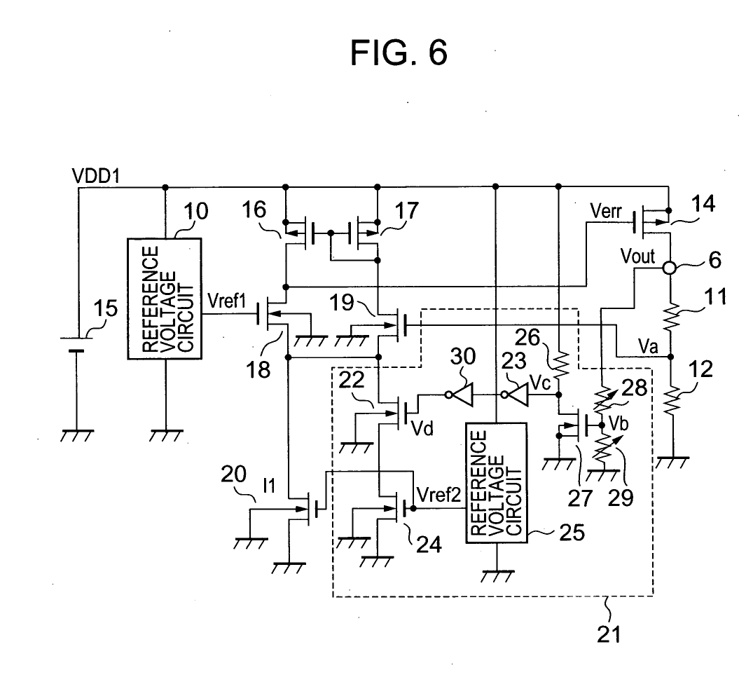

FIG. 6 is a circuit diagram showing a voltage regulator in accordance with a third embodiment of the present invention.

In the voltage regulator of the third embodiment, the breeder resistor 28 and the breeder resistor 29 are made up of a variable resistor, respectively. The value of Vb is controlled with the above structure, as a result of which a relationship between a current that is added to the error amplifier and the output voltage Vout at the time of a heavy load can be arbitrarily controlled. Hence, the invention can widely be applied to each product, and it is possible to optimally improve an undershooting characteristic and reduce the current consumption.

In the descriptions of the above first to third embodiments, the current adder circuit 21 is structured as shown in FIG. 2, but it is apparent that the same effects can be obtained even in other circuit structures having the identical functions.

1. A voltage regulator, comprising:
an error amplifier;
an output MOS transistor; and
a current adder circuit for detecting that an output voltage is lower than a predetermined voltage, and increasing an operating current of the error amplifier.

2. A voltage regulator according to claim 1, wherein the current adder circuit variably detects the predetermined voltage.

3. A voltage regulator according to claim 1, wherein the current adder circuit variably increases the operating current of the error amplifier.

4. A voltage regulator, comprising:
a reference voltage circuit for outputting a reference voltage;
a dividing resistor for dividing an output voltage;
an error amplifier for inputting the reference voltage and a voltage outputted from the dividing resistor;
an output switch for controlling the output voltage according to an output of the error amplifier; and
a current adder circuit for increasing the operating current of the error amplifier according to the output voltage, wherein the error amplifier comprises a first constant current source, and
wherein the current adder circuit comprises a voltage detector circuit for detecting the output voltage, a switch circuit that is controlled according to a signal from the voltage detector circuit, and a second constant current source that is connected in series to the switch circuit and connected in parallel with the first constant current source through the switch circuit.

5. A voltage regulator according to claim 4, wherein when the voltage detector circuit detects that the output voltage is lower than a predetermined voltage, and the switch circuit becomes in a connection state, and when a current in the second constant current source is allowed to flow, the current adder circuit increases the operating current of the error amplifier.

6. A voltage regulator according to claim 4, wherein the voltage detector circuit comprises variable resistors that are connected in series, and controls a detected voltage.

7. A voltage regulator according to claim 4, wherein the current in the second constant current source is variable.
